(19) United States
(12) Patent Application Publication
(10) Pub. No.: US 2016/0048836 A1
(43) Pub. Date: Feb. 18, 2016

(54) SECURE PAYMENT TRANSACTION SYSTEM

(71) Applicant: CLEVERADE, VALBONNE (FR)

(72) Inventors: Mikael SABATIER, VALBONNE (FR); Luc ANDRE, LACADEE (FR)

(21) Appl. No.: 14/780,561

(22) PCT Filed: Mar. 27, 2013
(86) PCT No.: PCT/IB2013/052468

§ 371 Date: Sep. 28, 2015

(51) Int. Cl. G06Q 20/40; G06Q 20/38

(52) U.S. Cl. CPC G06Q 20/405; G06Q 20/3829; G06Q 20/3827

(57) ABSTRACT

The present invention proposes a payment transaction system, comprising: •—a merchant server; •—a client device for connecting to the merchant server and interacting with same; •—a secure customer data server, •—a secure payment server distinct from said secure customer data server, • said secure customer data server having a memory storing payment instrument data in relation with a plurality of users, and being capable of interacting with said client device by: • receiving a payment instrument data request corresponding to a given user account, • establishing a secure session between said client device and the secure payment data server, • within that session, performing a secure, challenge-response type authentication transaction, and • upon successful authentication, receiving payment instrument data at said client device for providing to said merchant server, at least part of said data being ciphered, • said client device being adapted to decipher said ciphered part of said data and to transmit to said merchant server, or to said secure payment server, payment instrument data in a form useable by said server. This allows streamlining the payment process while having a high degree of safety. Said challenge-response authentication involves a hash function applied to a combination of a user password entered on said client device and a challenge received from said secure customer data server, in order to generate a one-time password for sending to said secure customer data server

### FIELD OF THE INVENTION

The present invention generally relates to transactional systems in a network environment such as the Internet.

### BACKGROUND OF THE INVENTION

A transaction on the Internet, e.g. for acquiring an article paid with a bank card, generally involves the following steps:
browsing a merchant server such as a merchant website to find the article;
clicking on a “buy” button so as to transfer the article to a virtual basket,
checking out at a virtual check-out point, including:
   generating a customer account data (name, login password, delivery address, etc.) if such account does not exist already, and logging-in as registered customer,
   effecting payment with a bank card at a secure payment server connected to the merchant server.

In some cases intended to increase the security of the process, at least one of the above steps is completed by an interaction on a separate communications channel, relying for instance on SMS or email, and/or on a third party website requesting to enter additional user-specific information (birthdate, special code, etc.).

Many tentatives have been conducted to make such transactions more streamlined, including the well-known “one-click shopping” system avoiding to enter bank card data a second time after they have been entered once in secure part of a given merchant server. The security level of such system is however not very high, and in addition does not simplify the life of the user as still a majority of merchant servers do not implement one-click shopping.

Other techniques nowadays involve the use of NFC technology, especially in real shopping, which however are not appropriate for Internet shopping as no NFC interaction between the customer and the merchant is by nature possible.

### SUMMARY OF THE INVENTION

The present invention seeks to alleviate these drawbacks, and to offer a transaction system, involving at the end a secure payment in a conventional form, allowing a customer to acquire an item (a good or a service) in a more streamlined process and in a manner similar to the process used in a real shop, i.e. by merely choosing one or several articles and by entering a short pin code after selecting a payment means.

More particularly, the present invention aims at providing a central and secured repository for payment instrument data of users, and to integrate the functionalities of such central repository with the entities involved in a purchase transaction (merchant server, client device and payment server) while simplifying the workload by the customer and avoiding the sources of fraud, errors and losses associated with manually entering payment data into client devices.

The present invention further aims at avoiding the hassle of having to create a user account each time a customer wants to purchase an item at a merchant at which he/she has not previously created a user account.

To this end, the present invention provides, according to a first aspect, a payment transaction system, comprising:
a merchant server;
a client device for connecting to the merchant server and interacting with same;
a secure customer data server,
a secure payment server distinct from said secure customer data server,
   said secure customer data server having a memory storing payment instrument data in relation with a plurality of users, and being capable of interacting with said client device by:
receiving a payment instrument data request corresponding to a given user account,
establishing a secure session between said client device and the secure payment data server,
within that session, performing a secure, challenge-response type authentication transaction, and
upon successful authentication, receiving payment instrument data at said client device for providing to said merchant server, at least part of said data being ciphered,
   said client device being adapted to decipher said ciphered part of said data and to transmit to said merchant server, or to said secure payment server, payment instrument data in a form useable by said server.

Preferred but non-limiting aspects of this system include the following features, taken individually or in any of their technically compatible combinations:
said authentication transaction involves at the client device level a user interface simulating a payment card terminal.
said user interface includes a display of the transaction price, and a display of a virtual keyboard for PIN-like input by means of an input device of the user device.
said challenge-response authentication involves a hash function applied to a combination of a user password entered on said client device and a challenge received from said secure customer data server, in order to generate a one-time password for sending to said secure customer data server.
said challenge is transmitted in ciphered form and deciphered by a private key uniquely associated to the client device and stored therein.
said client device stores a deciphering key for said ciphered payment instrument data, which is derived from said user password.
said secure customer data server includes means for interacting with said merchant server in order to automatically create a user account based on user information stored in said secure customer data server.
said ciphered part of payment instrument data includes a payment card verification value (CVV, CVC).

According to a second aspect, the present invention provides a method for performing a payment transaction, comprising:
at a client device, interacting with a merchant server for selecting for purchase a given item,
upon item selection, recovering from said merchant server redirection information towards a secure customer data server,
at said client device, establishing a secure session with said secure customer data server, provided that no such session is already in progress,
providing a request for payment instrument data to said secure customer data server,
receiving at said client device, from said secure payment data server, a variable authentication data item,
launching at said client device a user interface for inputting a user password,
combining said variable data item and said password to generate a one-time password,
transmitting said one-time password to said secure customer data server,
at said secure customer data server, provided that the one-time password has the expected value, transmitting to said client device payment instrument data, at least part of said payment instrument data being ciphered,
deciphering said ciphered payment instrument data at said client device by means of a deciphering key which is stored solely in said client device, and
transmitting from said client device to said merchant server, or to said secure payment server, payment instrument data in a form useable by said server.

Preferred but non-limiting aspects of this method include the following features, taken individually or in any of their technically compatible combinations:
said user interface simulates a hardware payment card terminal.
said user interface includes displaying a transaction price provided by said merchant server, and displaying a keyboard for PIN-like input, and listening to an input device for inputted secret code determination.
the method comprises the steps of:
   detecting at said customer data server whether a customer account exists for the merchant server, and
   in the negative, entering into a transaction with said merchant server for automatically creating a user account.
said step of providing a request for payment instrument data to said secure customer data server includes the selection of one payment instrument among a plurality of payment instruments for which data are stored in the secure customer data server.
said variable authentication data item is a challenge.
said challenge is transmitted in ciphered form and deciphered at said client device by means of a private key uniquely associated to said client device and stored therein.
said combining step includes a hash function on a combination of the entered user password and the received variable authentication data item.
said ciphered part of payment instrument data includes a payment card verification value (CVV, CVC).
said deciphering key comprises information used for creating said one-time password.
said deciphering key is based on said user password.
said interacting step is selected from the group comprising:
   interacting with merchant pages though a browser,
   interacting with the merchant server via a dedicated application,
   camera-reading of an optical code containing information directing to an item,
   NFC reading of a tag containing information directing to an item,
   image recognition,
   sound recognition.

According to a third aspect, the present invention provides a computerized client device, characterized in that it comprises in combination:

a network communications circuitry,

means for establishing a secure communications channel with a secure customer data server,

means for generating a graphical interface for entering a user password,

means for storing a user password entered on said graphical interface,

means for converting said user password into a one-time password from a variable authentication data item received from said secure customer data server, and for transmitting to said secure customer data server said one time password,

means for receiving from said secure customer data server payment instrument data, part of which is ciphered,

means for deciphering said ciphered part of said payment instrument data by means of a deciphering key derived from said user password.

Preferably but in a non-limiting manner, said means are implemented in a standalone application that can be launched in response to interaction of the client device with a merchant server capable of delivering redirection information towards the secure customer data server.

Finally, the present invention provides a customer data server, characterized in that it comprises in combination:
a network communications circuitry,
means for establishing secure communications channels with a plurality of client devices associated with respective users,
a memory storing a plurality of payment instrument data in association with respective users, at least part of said payment instrument data being ciphered with a respective ciphering key,
means for transmitting variable authentication data items to said client devices in responses to payment instrument data requests from said client devices,
means for determining a match between a response received from a client device and an expected response computed by said server, and
means for transmitting payment instrument data for a selected payment instrument when a match is determined.

Preferably but in a non-limiting manner, said memory further stores customer information adapter to user account creation at merchant servers, templates of queries for passing said customer information to merchant servers, and identifiers of merchant servers for which user accounts have already been created, user by user.

### BRIEF DESCRIPTION OF THE DRAWINGS

Other aims, aspects and advantages of the present invention will be better understood from the following description of a preferred embodiment thereof, made with reference to the appended drawings, in which:

FIG. 1 is a block diagram of a general hardware architecture in which the present invention can be implemented,

FIGS. 2A and 2B are block diagrams illustrating the main steps of a transaction process according to a first and a second embodiment of the present invention, with variants regarding delivery mode selection,

FIGS. 3A and 3B are flow charts illustrating the nature and timing of information exchange in a transaction process according to a first and a second embodiment of the present invention, respectively with normal authentication and strong authentication, and

FIG. 4 diagrammatically shows an example of a virtual credit card payment terminal displayed on a smartphone used as client terminal in a process of the present invention.

### DETAILED DESCRIPTION OF A PREFERRED EMBODIMENT

The system and method according to the present invention aim at automating and streamlining a number of user actions required for a buying transaction in a network environment such as the Internet, and relies upon a commercial handheld terminal such as a smartphone having Internet connectivity (whether through 3G or 4G, Wi-Fi, Bluetooth, etc.).

Another aim of the invention is to be OS-independent and intuitive, thus not requiring any specific knowledge from the user, while having a high degree of security.

### 1) Hardware Architecture

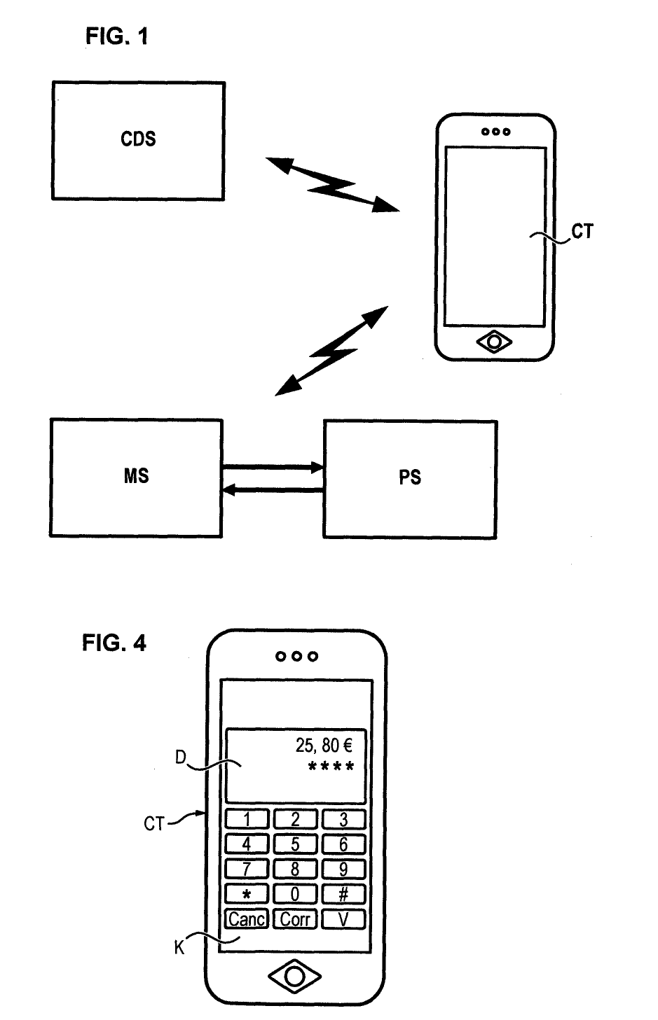

Referring to FIG. 1, the present invention is intended to be implemented in an environment comprising:
a merchant server MS hosting a merchant website with the usual functionalities, and in addition with a “direct buy” functionality as will be described in the following;
a client terminal CT such as a personal computer, a tablet, a smart phone, etc. having network connectivity,
a secure payment server PS, which can be of conventional type, capable of interacting with the merchant server, to receive payment particulars from a user through an appropriate interface and to validate a payment upon checking out at the merchant server, and
a secure customer data server CDS which can securely interact with the client terminal CT either via an internet browser of the terminal, or via a specific application hosted by the client terminal, as will be described in the following.

Of course this architecture is not limiting. For instance, the merchant server is not a website but is designed for directly interacting, through an appropriate protocol (proprietary or not) with a dedicated shopping application hosted by the client.

### 2) Functional Overview of the Invention

The present invention may involve four basic functionalities:
a secure payment process using an innovative strong authentication combining hardware and software and involving password deciphering; the arrangement is such that key information for payment can be deciphered only by a given client device used by its owner and in functional connection with the secure customer data server CDS during the purchase and physically identified for each payment transaction. The customer data server stores part of the payment data in a ciphered data base that cannot be used by third parties; the present invention allows integration with existing credit card payment schemes without the need for adaptations or changes, contrary to many proprietary solutions which often are at the end less secure (at the merchant side and at the user side) than the existing secure payment schemes;
an automated purchase process: a consumer can buy an item (product or service) without the prerequisite of having a customer account previously created and stored at the considered merchant; a user account can be created automatically and contextually, and further can be reused for future transactions; different variants may be implemented, depending on whether a delivery address and delivery mode selection is needed or not (needed for delivering physical articles, not needed for purchasing online services such as downloadable works, e-tickets, etc.); in addition, the interaction between the merchant server MS and the secure payment server PS is more streamlined, while in the existing processes the user has to manually input several payment instrument data (typically credit cart number, expiry date, name on card and CVC or CVV number) with associated tediousness and risk of typing errors.
ease of use: an aspect of the present invention allows users to transact on the Internet in a manner very similar to real shopping, in an embodiment by using a virtual credit card payment terminal similar to hardware payment terminals, or at list by inputting on a web page a single password at the payment stage; further, in addition to e-shopping by browsing merchant websites on the Internet or by selecting articles via a specific client-side shopping application interacting with a merchant site, the use of two dimensional codes such as QR Codes or Datamatrix codes, or alternatively NFC technologies, is fully compatible with the present invention and allows streamlining even further the purchase process; in addition, there is no complex learning process for the first user of the invention.
compatibility: the present invention can operate on any connected terminal, without additional hardware, through a single interface independently of the merchant's site or shopping application user interface.
convenience: a Single Sign On (SSO) process allows a user to access different purchase contexts (i.e. different merchant servers), the user being identified and authenticated by a ciphering method of adequate security level.

Such SSO process provides simplicity to the user by managing the whole lifecycle of the single password that protects his payment information, which can include several payment instruments. It further provides traceability of the authentication process so that users keep control on their transactions history.

The present invention further allows different degrees of security (public key ciphering, or private key ciphering implying the possession of a particular hardware—typically a smartphone—storing the private key uniquely associated thereto).

### 3) Detailed Implementation

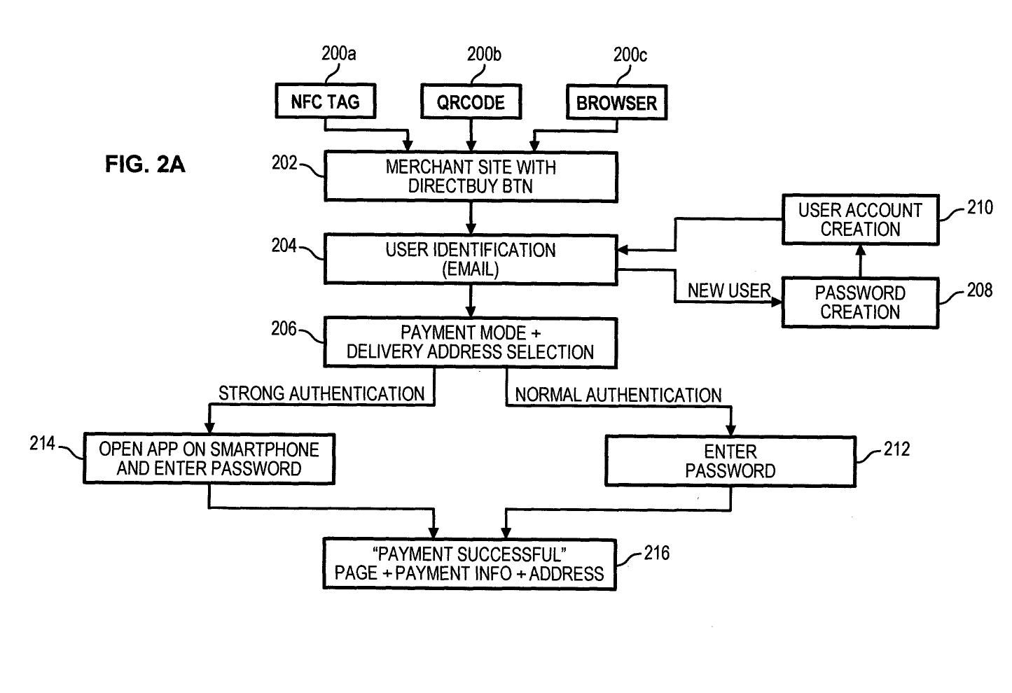

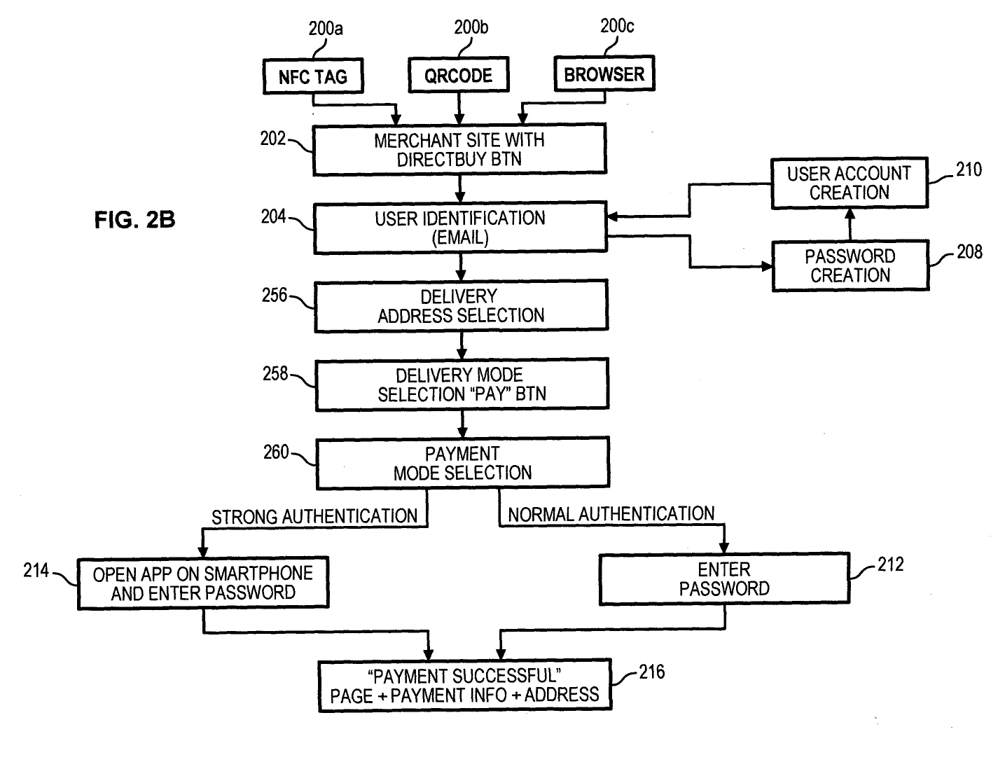

With reference to FIG. 2A, server, a website (202) in the particular example, can be accessed by any of a NFC tag identification made by a connected client terminal CT (200a), the reading of an optical code (typically a QR code) by a camera of the connected terminal CT (200b) or by a standard browser (200c) or terminal CT. Of course, other interaction techniques allowing to reach an item for purchase on the merchant website can be contemplated. In particular, the present invention can operate with image recognition techniques allowing to compare a snapshot of a given product with a database of product images, as well as sound recognition techniques, allowing to identify the name of a product (voice recognition with access to a database of product names) or a song (music recognition with access to a database of music file signatures).

The merchant website is provided with specific software allowing for a direct buying functionality according to the present invention. More particularly, to each item that can be subject to direct buying is associated on the corresponding web page a specific clickable button providing a “direct buy” indication or the like.

The browser is then redirected to the secure customer data server CDS where the user is prompted to identify himself, typically by entering his email address (box 204).

It should be noted here that the secure connection between the client terminal and the customer data server is preferably established by a login/password valid combination, the login being an email address of the customer and the password being the key used to cipher part of the payment instrument data (typically CVC or CVV) as will be detailed in the following.

Typically, a secure session between the client terminal and the secure customer data server is maintained as long as the client terminal hardware remains the same.

Entering the password another time will be requested typically (i) when a new piece of hardware is to be used as client terminal on behalf of a given user, and (ii) when a new payment instrument is to be inputted and stored in the customer data server, in which case the entered password is used for ciphering the CVC or CVV inputted by the user before transmitting it to the CDS server.

The customer data server CDS stores different types of user information, including information relating to the client accounts already created by the user at various merchant sites, in addition to payment instrument details for the user. More particularly, the CDS server stores customer information such as name, address, telephone number, email address, various profile information (e.g. shoe size, shirt size, and many other types of personal information), as well as a database containing identification of merchant servers for which user accounts have already been created, as well as all necessary information for encoding user information into http/https queries in a way compatible with existing or future merchant servers. Although this encoding is nowadays not fully standardized, a limited number of encoding templates, updated whenever necessary, will be able to cover a large proportion of situations.

If the CDS server determines that the user identified by the inputted email address already has an account created at this merchant site, then the process moves to a step of selection, by the user, of a payment mode and a delivery address (206).

Otherwise, the process is directed to a client account creation step where the user first selects a password for the client account (208), and then the CDS server interacts with the merchant site, in a manner preferably transparent to the user, so as to input into the merchant website, through the above-mentioned http or https template queries which have been stored in the CDS server in association with the considered merchant site, in which user information previously stored in the CDS such as full name, address, phone number, alternate email, secret question, profiled information, etc. is incorporated.

After such user account creation, the process moves to the above-mentioned step 206 where the user, still interacting with the CDS server, selects a payment mode (typically one among a plurality of credit cards, debit cards, etc. previously stored by the user), and also select a delivery address for the case where the purchased item is a physical article.

Thereafter, depending either on user choice, or other considerations, the process goes either to a normal authentication process for payment (box 212) or strong authentication process (box 214).

In a preferred embodiment, routing the process to the normal or to the strong authentication involves the following scheme: the user has the possibility to associate a terminal such as a smartphone in his account data stored in the secure customer data server. Associating a terminal involves that a special application for strong authentication is downloaded on the terminal for execution as explained in the following. The normal/strong authentication can then be selected e.g. depending on the amount of the transaction of other factors such as a “strong mode” request by the merchant sever, a merchant type, a geographical location, etc.

The normal authentication process involves, in a ciphered transaction with the CDS server, entering a password (identical to the client account password or different), and of course different from any PIN Code, CVC or CVV code of a credit card whose data are stored in the CDS server) on a specific page launched by the CDS server for authorizing the payment.

This is typically the case when for instance a user browses on the merchant site from a personal computer in a public area and not from a personal client device CT such as a smartphone.

(The secure process on converting the entered password into a one-time password OTP for the CDS server and securely transferring to the merchant site the credit card data will be described in the following.)

From there, the CDS server delivers to the merchant website the payment data stored in the CDS (typically credit card number, CVV code, expiry date, read from the CDS memory) through a https query, and the merchant site then interacts with the secure payment server, in a conventional way, to validate the payment. The merchant site then delivers to the user terminal a page indicating the success of the payment stage, together with any associated information (box 216).

Alternatively, a strong authentication process (214) involves launching, typically on a user's smartphone CT, a special application capable of graphically emulating a real credit cart payment terminal, as shown in FIG. 4, and inviting the user to enter a pass code, with a higher degree of security as will be described later.

After successful password entry, the payment is processed between the merchant site MS and the secure payment server PS as described above (216).

FIG. 2B illustrates a variant embodiment of this general process.

Similar steps of functionalities are designated by the same reference numbers, the major different being that step 206 of FIG. 2A is replaced by a succession of the following steps:
a step 256 of selection of a delivery address by interaction with the CDS server, after which the user is redirected to the merchant site,
a step 258 of selection of delivery mode and “direct pay” button activation at the merchant site, after which the user is directed back to the CDS server, and
a step 260 of selection of a payment mode (typically as mentioned above, selection of one particular credit/debit card).

The process then jumps to step 212 or 214, as previously described.

This variant allows taking into account merchant websites MS where a delivery mode impacts the total price to be paid for the purchase (typically normal or express delivery, etc.).

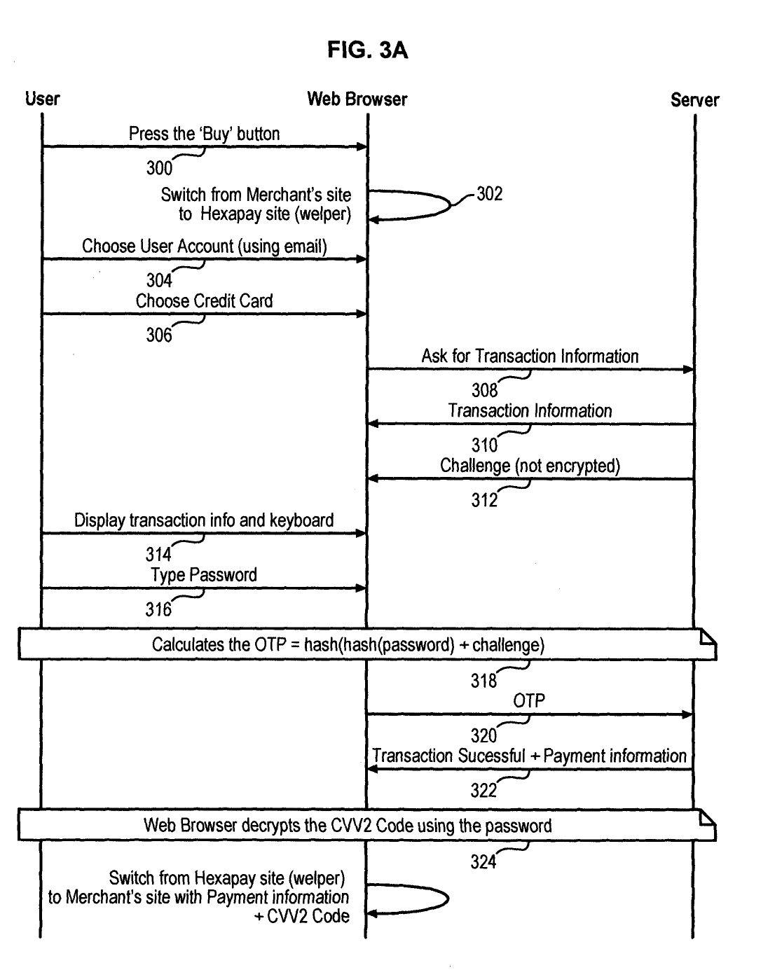

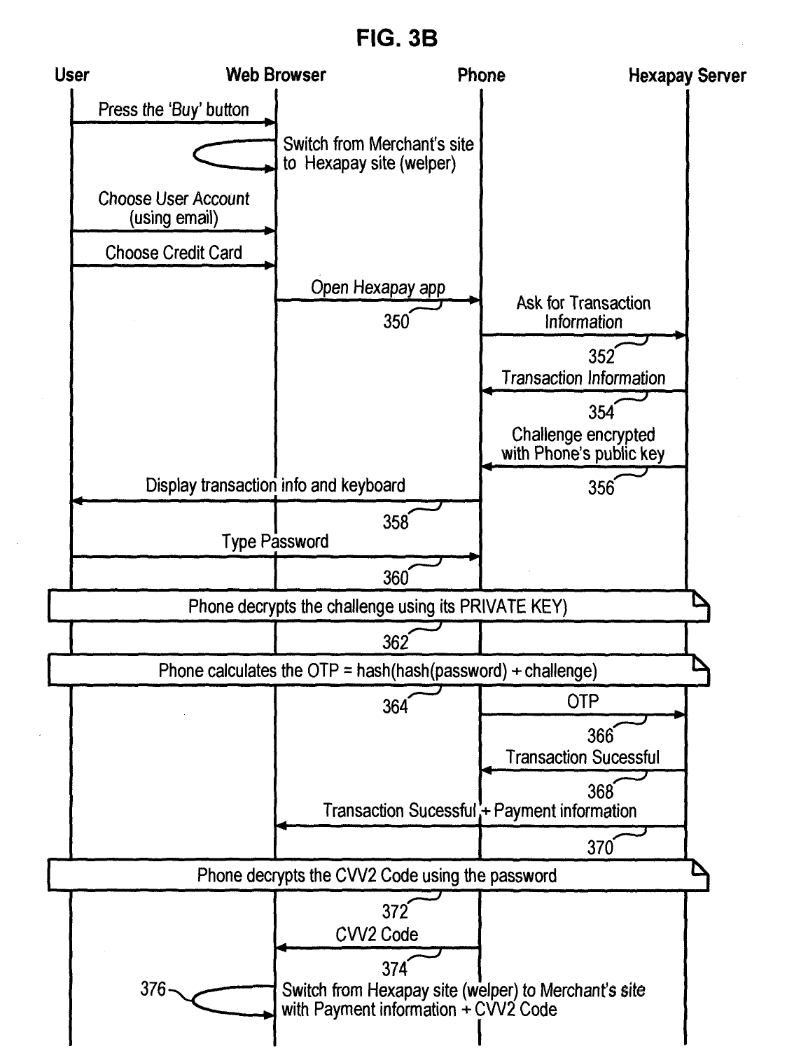

Now referring to FIG. 3A, the detailed implementation of the steps performed at the entities of the overall system is described, in the “normal authentication” mode.

The three vertical lines respectively illustrate, from left to right, user action (at input devices of the client terminal), browser action at the client terminal CT and CDS server action.

At a first step of the process of the invention, the user presses the button “direct buy” at the merchant site (300), which causes a redirection to the CDS server (302).

The next step is logging-in at the CDS server (304) and either logging-in as client on the merchant website (if an account for the considered user already exists), or create user account and login, as explained above.

The next step is, within a secure (https) transaction between the client terminal and the CDS server, a payment mode selection or credit card selection (306) by the user, which in turn generates, a request for transaction information 308 to the CDS server. In response to this request, the CDS server delivers (at 310) the transaction information as well as (at 312) a challenge.

Typically, the transaction information comprises at least the card number, expiry date and name on card of the payment card, and a flag indicative of the security level (strong or normal, cf. above). Optionally, it can further contain scoring information of the user (typically new user, frequent user, potential cheater, etc.), the GPS position of the client terminal, and identifiers of the client terminal (IMEI number, phone number, etc.). The CVC/CVV is not contained in this information.

Controlled by the CDS server, the browser generates a web page with transaction info (information on the selected credit card and the amount of the transaction is typically displayed at that stage) and calling for the inputting of a payment password by the user (316). This password is the same as the one used to cipher the CVC/CVV in the terminal, before sending it to the CDS server, when creating in said server a new payment instrument.

The browser, e.g. through a JavaScript, generates a one-time-password OTP by applying a predetermined hash function to the inputted payment password and then applying another hash function to the concatenation of the hashed password and the challenge (box 318), and this one-time password OTP is transmitted from the client browser to the CDS server (320).

The CDS server compares the received OTP with the expected response corresponding to the challenge sent at 312 (the CDS server having previously stored in its memory the hashed password). In case of match, the CDS server sends to the client browser (322) information indicating that the authentication of the payment instrument is successful, together with the payment information containing at least the CVC or CVV code of the card in ciphered form.

The client browser, using e.g. an appropriate JavaScript, deciphers the CVC or CVV code (box 324) and then the browser is redirected to the merchant site through an https query containing the deciphered CVC or CVV code, so that the merchant site can then interact with the secure payment server PS to effect actual payment of the purchased item, in the conventional way.

It should be noted here that the payment information other than the CVC/CVV can be provided to the merchant server:
either, by appropriate redirections, directly from the CDS server,
or by the client terminal.

FIG. 3B illustrates the strong authentication embodiment of the present invention, relying on a specific application launched on a smartphone of the user (whether the client browser is run of the same smartphone or on a different machine).

The steps and information exchange identical to those of FIG. 3A are designated by the same reference numbers.

Steps 300 to 306 are identical to those of FIG. 3A.

At step 350, the client browser of the smartphone, after receiving information as to the selected credit card, sends a command to the operating system of the smartphone in order to launch a dedicated direct payment application. This application uses the smartphone connectivity to enter into a transaction with the CDS server and requests transaction information at 352. In response to this request, transaction information is sent to the application at 354. The CDS server further responds by transmitting to the application a challenge which is ciphered with a public key which is stored both at the CDS server and in the smartphone CT (356).

The application then displays on the smartphone display device a virtual credit card payment terminal, e.g. such as shown in FIG. 4 of the drawings, together with at least part of the transaction information (typically the payable amount).

On this emulated payment terminal, the user, much like when making a payment on a real terminal, enters on a virtual keyboard K a password (typically a four-digit password), which preferably is different from the PIN code associated to the card, and from the password required for connection to the CDS server. The emulated payment terminal also includes a display area D similar to the one of a real payment terminal.

The user types the password at 360. At the same time, or beforehand or subsequently, the smartphone application deciphers at 362 the challenge received at 356 from the CDS server, and then, at 364, calculates the one-time password by applying a hash function to the password entered at 360, and a further hash function to the concatenation of the hashed password and the deciphered challenge.

The result of this computation is transmitted to the CDS server at 366. If such responds matches the expected response (being noted that the CDS server already stores the hashed password), the CDS server then sends to the application information indicating that the authentication of the payment instrument was successful (368).

The application in turn connects to the browser of the smartphone and provides credit card data (credit card number and expiry date, name of holder) in order that the browser queries the merchant site accordingly (step 370).

In parallel, or just before or after, the application deciphers the CVC or CVV code by means of the private key uniquely associated to the smartphone (or other communicating device), at step 372, and conveys the CVC or CVV code to the browser (374), after which the browser can send the full payment instrument data, in useable form, to the merchant server MS (376) or alternatively directly to a secure payment server PS for payment, in a manner which can be conventional per se.

It is understood that, whatever the embodiment, the system of the present invention is largely compatible with merchant servers, and fully compatible with existing secure payment schemes. In this regard, the type of payment instrument data securely stored by the customer data server is totally flexible.

The present invention is not limited to the embodiments described and illustrated, but the skilled person will be able to devise many variants based on his general knowledge in the field.

In particular, and as already explained, the present invention can also fully apply to transactions made by interaction between a dedicated server and a dedicated application associated thereto, executed on the client terminal.

1. A payment transaction system, comprising:
a merchant server;
a client device for connecting to the merchant server and interacting with same;
a secure customer data server,
a secure payment server distinct from said secure customer data server, said secure customer data server having a memory storing payment instrument data in relation with a plurality of users, and being capable of interacting with said client device by:
receiving a payment instrument data request corresponding to a given user account,
establishing a secure session between said client device and the secure customer data server,
within that session, performing a secure, challenge-response type authentication transaction, and
upon successful authentication, receiving payment instrument data at said client device for providing to said merchant server, at least part of said data being ciphered,
said client device being adapted to decipher said ciphered part of said data and to transmit to said merchant server, or to said secure payment server, payment instrument data in a form useable by said server.

2. A system according to claim 1, wherein said authentication transaction involves at the client device level a user interface simulating a payment card terminal.

3. A system according to claim 2, wherein said user interface includes a display of the transaction price, and a display of a virtual keyboard for PIN-like input by means of an input device of the user device.

4. A system according to claim 2, wherein said challenge-response authentication involves a hash function applied to a combination of a user password entered on said client device and a challenge received from said secure customer data server, in order to generate a one-time password for sending to said secure customer data server.

5. A system according to claim 4, wherein said challenge is transmitted in ciphered form and deciphered by a private key uniquely associated to the client device and stored therein.

6. A system according to claim 4, wherein said client device stores a deciphering key for said ciphered payment instrument data, which is derived from said user password.

7. A system according to claim 1, wherein said secure customer data server includes means for interacting with said merchant server in order to automatically create a user account based on user information stored in said secure customer data server.

8. A system according to claim 1, wherein said ciphered part of payment instrument data includes a payment card verification value (CVV, CVC).

9. A method for enabling a payment transaction, comprising:
at a client device, interacting with a merchant server for selecting for purchase a given item,
upon item selection, recovering from said merchant server redirection information towards a secure customer data server,
at said client device, establishing a secure session with said secure customer data server, provided that no such session is already in progress,
providing a request for payment instrument data to said secure customer data server,
receiving at said client device, from said secure payment data server, a variable authentication data item,
launching at said client device a user interface for inputting a user password,
combining said variable data item and said password to generate a one-time password,
transmitting said one-time password to said secure customer data server,
at said secure customer data server, provided that the one-time password has the expected value, transmitting to said client device payment instrument data, at least part of said payment instrument data being ciphered,
deciphering said ciphered payment instrument data at said client device by means of a deciphering key which is stored solely in said client device, and
transmitting from said client device to said merchant server, or to a secure payment server, payment instrument data in a form useable by said server.

10. A method according to claim 9, wherein said user interface simulates a hardware payment card terminal.

11. A method according to claim 10, wherein launching said user interface includes displaying a transaction price provided by said merchant server, and displaying a keyboard for PIN-like input, and listening to an input device for inputted secret code determination.

12. A method according to claim 9, comprising the steps of:
detecting at said customer data server whether a customer account exists for the merchant server, and
in the negative, entering into a transaction with said merchant server for automatically creating a user account.

13. A method according to claim 9, wherein said step of providing a request for payment instrument data to said secure customer data server includes the selection of one payment instrument among a plurality of payment instruments for which data are stored in the secure customer data server.

14. A method according to claim 9, wherein said variable authentication data item is a challenge.

15. A method according to claim 14, wherein said challenge is transmitted in ciphered form and deciphered at said client device by means of a private key uniquely associated to said client device and stored therein.

16. A method according to claim 9, wherein said combining step includes a hash function on a combination of the entered user password and the received variable authentication data item.

17. A method according to claim 9, wherein said ciphered part of payment instrument data includes a payment card verification value (CVV, CVC).

18. A method according to claim 9, wherein said deciphering key comprises information used for creating said one-time password.

19. A method according to claim 18, wherein said deciphering key is based on said user password.

20. A method according to claim 9, wherein said interacting step is selected from the group comprising:
interacting with merchant pages though a browser,
interacting with the merchant server via a dedicated application,
camera-reading of an optical code containing information directing to an item,
NFC reading of a tag containing information directing to an item,
image recognition,
sound recognition.

21. A computerized client device, comprising in combination:
a network communications circuitry,
means for establishing a secure communications channel with a secure customer data server,
means for generating a graphical interface for entering a user password,
means for storing a user password entered on said graphical interface,
means for converting said user password into a one-time password from a variable authentication data item received from said secure customer data server, and for transmitting to said secure customer data server said one time password,
means for receiving from said secure customer data server payment instrument data, part of which is ciphered,
means for deciphering said ciphered part of said payment instrument data by means of a deciphering key derived from said user password.

22. A computerized client device according to claim 21, wherein said means are implemented in a standalone application that can be launched in response to interaction of the client device with a merchant server capable of delivering redirection information towards the secure customer data server.

23. A secure customer data server, comprising in combination:
a network communications circuitry,
means for establishing secure communications channels with a plurality of client devices associated with respective users,
a memory storing a plurality of payment instrument data in association with respective users, at least part of said payment instrument data being ciphered with a respective ciphering key,
means for transmitting variable authentication data items to said client devices in responses to payment instrument data requests from said client devices,
means for determining a match between a response received from a client device and an expected response computed by said server, and
means for transmitting payment instrument data for a selected payment instrument when a match is determined.

24. A server according to claim 23, wherein said memory further stores customer information adapter to user account creation at merchant servers, templates of queries for passing said customer information to merchant servers, and identifiers of merchant servers for which user accounts have already been created, user by user.
